(19) United States
(12) Patent Application Publication
(10) Pub. No.: US 2009/0294036 A1
(43) Pub. Date: Dec. 3, 2009

(54) PRESS AND METHOD FOR LAMINATING ESSENTIALLY PLATE-SHAPED WORKPIECES

(75) Inventors: Dagmar Metzger, Karlsruhe (DE); Norbert Damm, Karlsdorf-Neuthard (DE); Gerhard Dolker, Baiersbronn (DE); Wolfgang Renz, Freudenstadt (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: ROBERT BURKLE GMBH, Freudenstadt (DE)

(21) Appl. No.: 12/469,090

(22) Filed: May 20, 2009

(30) Foreign Application Priority Data
May 29, 2008 (DE) 102008025790.7

(51) Int. Cl. B29C 43/20; B30B 5/02

(52) U.S. Cl. 156/219; 156/583.3

(57) ABSTRACT

A press and a method for laminating essentially plate-shaped workpieces under the effect of pressure and heat. In the closed state, a lower press half and an upper press half form a vacuum chamber utilizing a peripheral, one-part, or multi-part seals. A flexible membrane divides the vacuum chamber into a product half that can be evacuated that holds at least one workpiece and a pressure half that can be pressurized. The membrane is constructed and arranged so that it presses the workpiece directly or indirectly against a bottom side of the vacuum chamber due to a pressure difference generated in the vacuum chamber due to the evacuation of the product half and/or due to the pressurization of the pressure half. The membrane is mounted on a membrane frame that can be handled separately and that is connected detachably to the upper press half and that can be mounted on the membrane frame or tensioned in the frame from outside of the press. At least one membrane frame with a membrane mounted on the frame is stored as a replacement frame outside of the press in a magazine.

### CROSS-REFERENCE TO RELATED APPLICATIONS

This application claims the benefit of German Application No. DE 10 2008 025 790.7, filed May 29, 2009, which is incorporated herein by reference as if fully set forth.

### BACKGROUND

The invention relates to a press for laminating essentially plate-shaped workpieces under the effect of pressure and heat and also to a method for laminating such workpieces under the effect of pressure and heat.

Presses of this type generally comprise a lower press half and an upper press half that form a vacuum chamber in the closed state, by the use of peripheral, one-part or multi-part seals, with the vacuum chamber being divided by a flexible membrane into a product half and a pressure half. The product half of the vacuum chamber is used for holding at least one workpiece and can be evacuated, while the pressure half is formed so that it can be pressurized. Due to a pressure difference in the vacuum chamber generated by the evacuation of the product half and/or by pressurization of the pressure half, the workpiece is pressed by the membrane directly or indirectly against a bottom side of the vacuum chamber, in order to perform the lamination process.

A method for laminating essentially plate-shaped workpieces under the effect of pressure and heat of the present type is performed using such a press. Here, at least one workpiece is brought into a vacuum chamber formed by a lower press half and an upper press half and divided by a flexible membrane into a product half and a pressure half, and the workpiece is arranged in this chamber in the product half. The product half is then evacuated and/or the pressure half is pressurized, so that the membrane presses the workpiece directly or indirectly against a lower side of the vacuum chamber due to the generated pressure difference in the vacuum chamber, in order to perform the lamination process.

A press of the present type is preferably used for laminating photovoltaic modules. Here, advantageously a multi-stage press is used that comprises a number of heating plates between each of which a press stage is formed. Above each heating plate, on the bottom side of the heating plate arranged thereabove, there is a sealing frame that circumscribes a vacuum chamber that can be evacuated when the press stage is closed through a tight placement of the sealing frame on the heating plate lying underneath. Through the use of the sealing frame, an elastic or flexible membrane is tensioned that divides the vacuum chamber into a product half and a pressure half and is also used as a pressing device, in order to apply the pressure necessary for the lamination of the photovoltaic module against the lower heating plate. Here, for a closed press, the volume that lies under the membrane and between this membrane and the heating plate and that forms the product half of the vacuum chamber is evacuated, wherein the membrane is mounted close to the workpiece. In addition, if necessary, a pressure half of the vacuum chamber formed by sealing the sealing frame against the upper heating plate and defined at the bottom by the membrane is pressurized with compressed air, in order to increase the contact pressure between the membrane and the workpiece. The evacuation of the product half here allows a bubble-free lamination of the workpiece, because possible air inclusions and the like are drawn out before reaching the softening temperature of the adhesive used in the workpiece. Through the contact of the workpiece with the lower heating plate, this heats up past the softening temperature and the curing temperature of the adhesive normally contained in adhesive layers in the workpiece, so that the lamination process can be continued up to the complete hardening of the adhesive.

For achieving the highest possible cost efficiency in the lamination of workpieces in a press of the present type, one strives to keep the cycle times as short as possible. However, there are limits to the reduction of the cycle times in that the time period of the lamination process cannot be shortened arbitrarily. For achieving a high cost efficiency it is also important to shorten other times outside of the actual lamination process, such as, for example, heating and cooling processes, but in particular, production stoppages.

Here, the replacement of a membrane that has become defective has proven to be a time factor that is not to be underestimated. The flexible membrane of a press of the present type must withstand high mechanical loads and is subjected to corresponding wear. After typically 2000 to 3000 lamination cycles, the membranes are worn and must be replaced.

In order to replace a membrane of a lamination press of the present type, the press must be shut down and cooled, so that the membrane is accessible for the operating personnel. After disassembly of the defective or worn membrane, a new membrane must be installed and tensioned. In order to be able to then resume production, the press or its heating plate must be heated again to operating temperature. The replacement of a membrane thus leads to a production stoppage of typically two to three hours.

For multi-stage presses that have a number of vacuum chambers arranged one above the other with lower and upper press halves (wherein, as a rule, the upper press half of a first vacuum chamber is formed by the heating plate that simultaneously forms the lower press half of the next vacuum chamber located thereabove), this problem multiplies in difficulty. This is because, first, the membranes in individual vacuum chambers are significantly more difficult to access compared with a press with only one vacuum chamber and, second, the cooling and heating processes last significantly longer. In addition, for each defect in an individual membrane in any of the several vacuum chambers arranged one above the other, the entire multi-stage press must be shut down.

Indeed, even if there are no membrane defects, outside of defects caused by wear, as soon as a first membrane defect caused by wear occurs, either all of the membranes must be replaced as a precaution, which results in corresponding extra costs, or else the production stoppages due to membrane defects that are caused by wear and that affect the entire multi-stage press become more numerous compared with a single-stage press.

For simplifying the replacement of a membrane, in EP 1 609 597 A2 it has been proposed to attach the membrane to a membrane frame that can be handled separately and that is connected detachably on its side to the upper press half. The membrane can be attached outside of the press to the membrane frame that can be handled separately. Then the membrane frame can be pushed into the press without a tool in a slide guide on the bottom side of the upper press half. This naturally considerably accelerates the replacement of damaged or worn membranes. However, the replacement of a membrane according to this state of the art requires trained personnel who must remove and insert the membrane frame from and into the press by hand. Furthermore, there is a considerable risk of injury here for the personnel if the laminating press has not cooled down in advance. Finally, according to the surface area of the membrane in use, which can equal several square meters, it is consequently barely possible to insert the correspondingly large surface-area membrane frame into the slide guide or to remove it from this guide; in any case, several persons are needed for this task.

### SUMMARY OF THE INVENTION

Starting from this state of the art, the present invention is based on the object of further improving a press of the type noted above with respect to production stoppages required due to membrane wear.

This objective is met by a press with the features according to the invention and also by a method according to the invention.

Preferred constructions of the press and method according to the invention are described in detail below.

According to the present invention, at least one membrane frame with a membrane mounted on this frame should be stored outside of the press as a replacement frame. A membrane-frame magazine is used for this purpose in the press according to the invention. In this way, the time required for replacing a membrane that has become defective is limited to the removal of the membrane frame together with the membrane from the vacuum chamber and inserting the ready-to-use membrane frame stored as a replacement frame with a mounted or tensioned membrane.

With the concept according to the invention, for continuous production, the replacement frame could be provided with a new membrane that could be mounted on the membrane frame or inserted into this frame as a precaution, in turn, advantageously without time pressure. If a multi-stage press is used, it could be sufficient to store only one or two extra membrane frames as replacement frames.

Here it is especially advantageous if the membrane frame could be attached to the upper press half utilizing quick-release closures. Such quick-release closures could then be operated advantageously by operating personnel even when the press is at the operating temperature, so that the cooling and heating cycles for replacing a defective membrane could be eliminated.

Special advantages are given when the membrane frame is divided into an upper membrane frame half and a lower membrane frame half between which the membrane is tensioned. In this way, the handling of the membrane frame with the tensioned membrane is simplified, because the membrane is better protected by its “internal” arrangement.

In particular, for such a two-part construction of the membrane frame, this could be provided on the upper side and lower side with seals and could form the sealing frame for forming the vacuum chamber between two otherwise flat press halves—these could be individual heating plates of a multi-stage press. It is preferred, however, when the membrane frame is somewhat smaller than the vacuum chamber and can be mounted within the vacuum chamber on the upper press half. In this respect, if the membrane frame is not part of the seal of the vacuum chamber, then a higher robustness is produced for the handling of this part performed outside of the press.

For the mechanical introduction of the membrane frame according to the invention into the vacuum chamber and back out from this chamber, it is very advantageous if transport frames for the membrane frames are provided on which the membrane frames could then be fed and discharged by loading and/or unloading devices for feeding or discharging the workpieces into and out from the vacuum chamber. Such mechanical introduction of the membrane frame is used in order to provide the capability of performing the membrane replacement even though the press is kept at the operating temperature. This method also shortens the replacement times considerably.

The membrane-frame magazine for storing prepared membrane frames can be allocated to the loading and/or unloading devices, wherein, advantageously, a membrane frame replacement station is provided from which the loading and/or unloading devices or the membrane-frame magazine can be loaded with membrane frames when necessary. The latter is especially advantageous when the press has a multi-stage construction and when a loading basket with several stages is used. This loading basket could then advantageously have a separate membrane frame stage in which a prepared membrane frame with a tensioned membrane is always stored.

In particular, for the lamination of photovoltaic modules it is advantageous when the press according to the invention is a multi-stage press in which several press stages are arranged one above the other each with a lower press half and an upper press half for each press stage that together form a vacuum chamber, wherein each of the press stages has a membrane frame with a tensioned membrane that can be mounted detachably on the corresponding upper press half and that can be handled separately. This is because the yield of electrical energy from photovoltaic modules is directly proportional to the surface area of the module. The arrangement of several press stages one above the other increases the laminated module surface area without increasing the surface area requirements on the production site.

Independent from whether a press with only one stage or a multi-stage press is used, for the method according to the invention a membrane-frame magazine with advantageously at least two stages is used by means of which the membrane frame can be introduced into the vacuum chamber and can be removed again from this chamber. In a first stage of this membrane-frame magazine, a membrane frame provided with an intact membrane is stored as a replacement frame. If there is a membrane defect, the membrane frame with the defective membrane is discharged from the vacuum chamber into a second stage of the membrane-frame magazine and then the membrane frame stored as a replacement frame is fed from the first stage into the vacuum chamber. In particular, if the membrane frame is to be attached to the upper press half utilizing quick-release closures, an accelerated replacement of a defective membrane with correspondingly short production stoppages is produced by this procedure, which could be optimized more if the membrane frame is fed in a transport frame into the vacuum chamber, wherein this transport frame is preferably provided with lift elements, in particular, lift elements that can be activated by hand from the outside for lifting the membrane frame to the upper press half.

### BRIEF DESCRIPTION OF THE SEVERAL VIEWS OF THE DRAWINGS

Embodiments for presses constructed according to the invention are described and explained in greater detail below with reference to the accompanying drawings. Shown are:

FIG. 1 is a schematic side partial diagram of a press constructed according to the invention,

FIG. 2 is a schematic side partial diagram of a loading basket to be place before the press shown in FIG. 1,

FIG. 2 shows a part from FIG. 2, but for a different embodiment,

FIGS. 3a and 3b are a side diagram and a top view onto a membrane-frame magazine that is simultaneously a membrane frame replacement station,

FIGS. 4a and 4b are a side view and a top view onto another membrane-frame magazine or another membrane frame replacement station, and

FIGS. 5a and 5b are a side view and a top view onto another membrane-frame magazine.

### DETAILED DESCRIPTION OF THE PREFERRED EMBODIMENTS

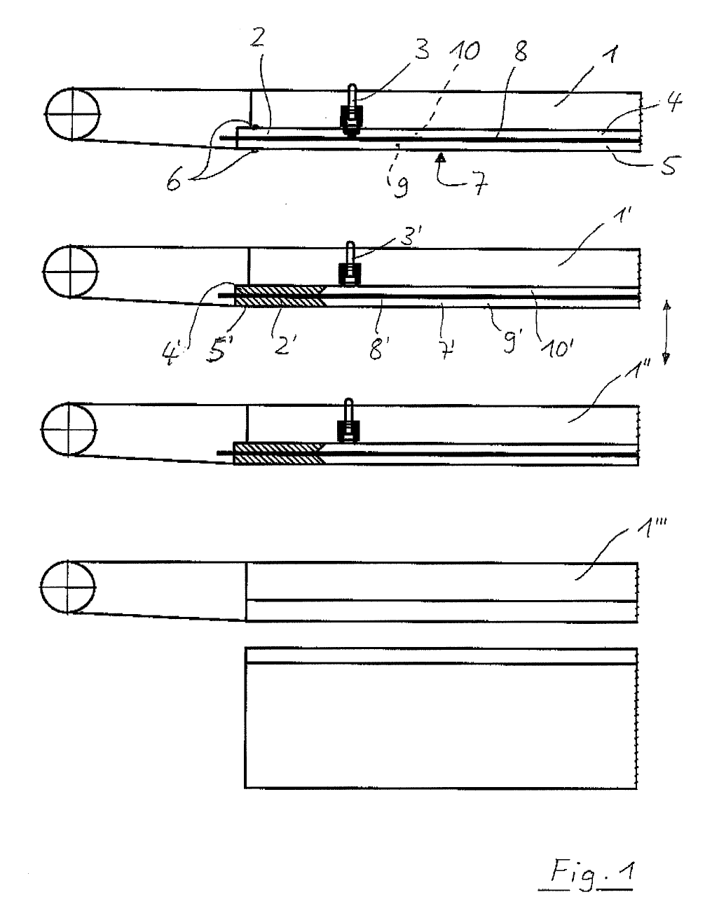

In FIG. 1, a press constructed according to the invention is shown in a schematic partial diagram, wherein here four heating plates 1, 1′, 1″, 1′″ form three press stages arranged one above the other, wherein the heating plate 1 forms the upper press half of the uppermost press stage and the heating plate 1′ is the lower press half of the uppermost press stage and also simultaneously the upper press half of the middle press stage. A membrane frame 2 that can be handled separately is attached by quick-release closures 3 to the upper press halves, in the example the uppermost press stage, that is, to the uppermost heating plate 1. The quick-release closures 3 are accessible at the side from the outside, so that they can be detached without the heating plate 1 having to cool. They can be made from a quick-release tension lever that is attached so that it can pivot on the heating plate 1 and that can engage in undercut recesses 19 in the membrane frame 2. Obviously, however, various other known types of quick-release closures and fast-disconnect connections are possible.

The membrane frame 2 is made from an upper membrane frame half 4 and a lower membrane frame half 5 and is sealed by peripheral seals 6 in the closed state of the press against the heating plates 1 and 1′, so that it forms, in its interior, a vacuum chamber 7. This is divided by a flexible membrane 8 into a product half 9 and a pressure half 10, wherein the membrane 8 is tensioned between the upper and the lower membrane frame halves 4, 5. The tensioning of the membrane 8 in the membrane frame 2 is performed outside of the press; together with the membrane frame 2, the membrane 8 can be removed from the press or inserted into the press when needed. In the example of the middle press stage that is formed by the second-uppermost heating plate 1′ and the third-uppermost heating plate 1″, it is illustrated in a partially sectioned diagram how the interior of the membrane frame 2′ looks and how the membrane 8′ divides the vacuum chamber 7′ formed by the membrane frame 2′ into a product half 9′ and a pressure half 10′.

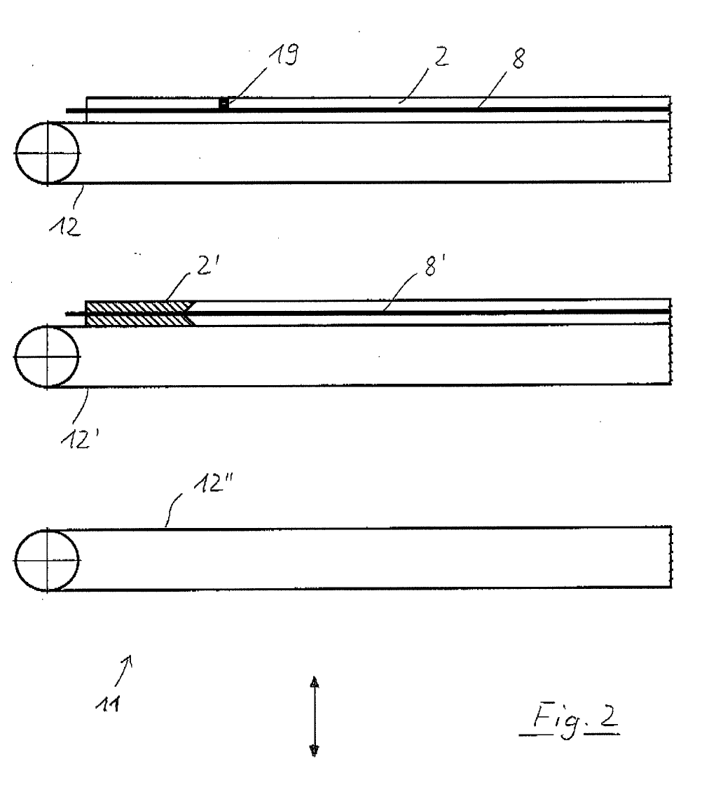

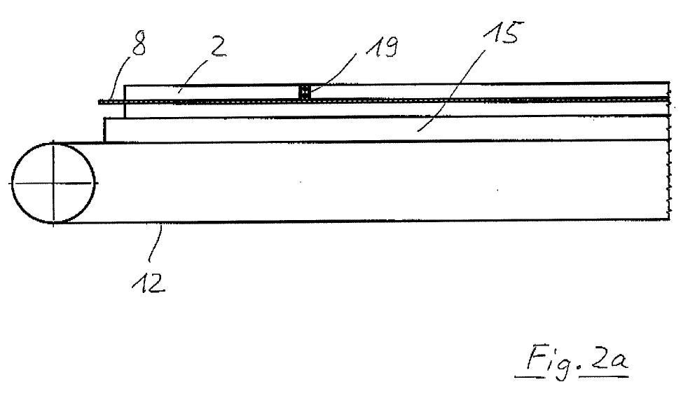

In a side schematic diagram, FIG. 2 shows a loading basket 11 for a multi-stage press as shown in FIG. 1. This loading basket 11 is made from several stages with transport belts 12, 12′, 12″ for feeding and discharging the plate-shaped workpieces to the individual press stages. The uppermost transport belt 12 forms an additional membrane frame stage in which a prepared membrane frame 2 is stored with a tensioned membrane 8, so that, when necessary, it can be fed into the stage of the press from which, on the outlet side, a membrane frame with, for example, a defective membrane has been discharged. As already mentioned, this can take place at the operating temperature of the press, because the quick-release closures 3 are accessible from the side of the press from the outside and the feeding and discharging of the membrane frame 2 are performed mechanically.

Another membrane frame 2′ is shown, in turn, in a partially sectioned diagram for better illustration on the middle transport belt 12′ of the loading basket 11 shown in FIG. 2. In the present embodiment, this stage of the loading basket 11 should normally not store a membrane 8′ in a membrane frame 2′; in other embodiments, however, this is definitely possible or this stage of the loading basket 11 is provided for discharging a membrane frame 2′ with a defective membrane 8′.

FIG. 2a shows the uppermost transport belt 12 of the loading basket 11 shown in FIG. 2, wherein, here, however, the membrane frame 2 with the membrane 8 and recess 19 for the quick-release closures 3 is stored on a transport frame 15. The transport frame 15 has the same dimensions as the (not shown) transport frame for the workpieces to be laminated, so that the membrane frame 2 can be transported on the transport frame 15 in the same way as the workpieces to be laminated in all of the transport means of the entire device.

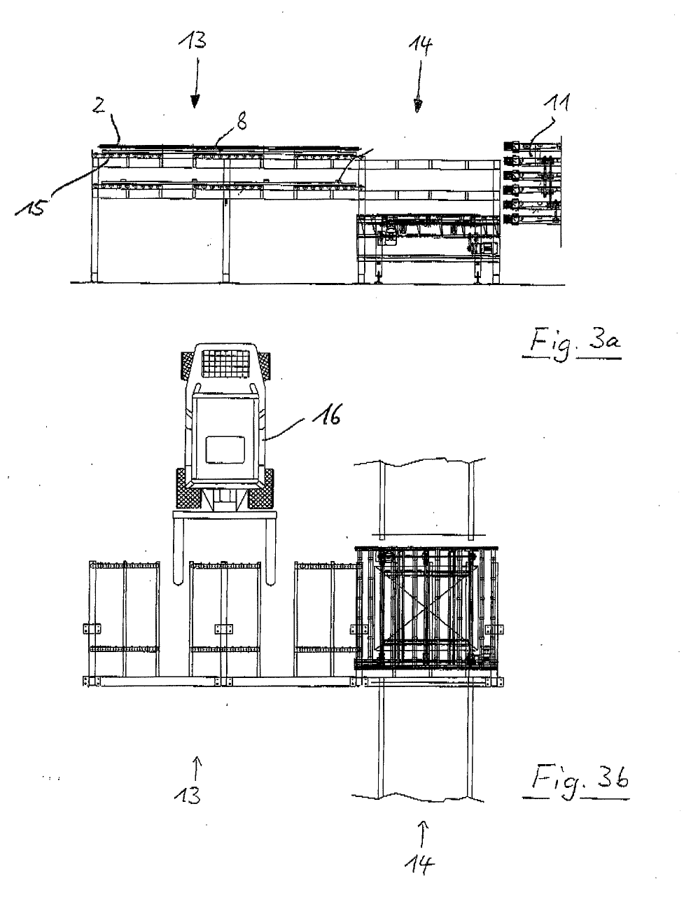

FIG. 3a shows a side diagram of a membrane-frame magazine constructed as a membrane frame replacement station 13, while FIG. 3b shows a top view of this same construction. The membrane frame replacement station 13 is arranged before the loading basket 11, wherein a cross transport device 14 is arranged between the membrane frame replacement station 13 and the loading basket 11 for feeding the workpieces to be laminated. In the membrane frame replacement station 13, a membrane frame 2 with a tensioned membrane 8 is stored, that is, on a transport frame 15 that is constructed according to the workpieces to be laminated or their transport frames and thus guarantees that the membrane frame 2 can be transported into and out of the press without a problem with existing transport means to the loading basket 11. A fork stacker 16 can lift the membrane frame 12 out from the membrane frame replacement station 13, in order to be able to load it with a new membrane 8 at a separate (not shown) station.

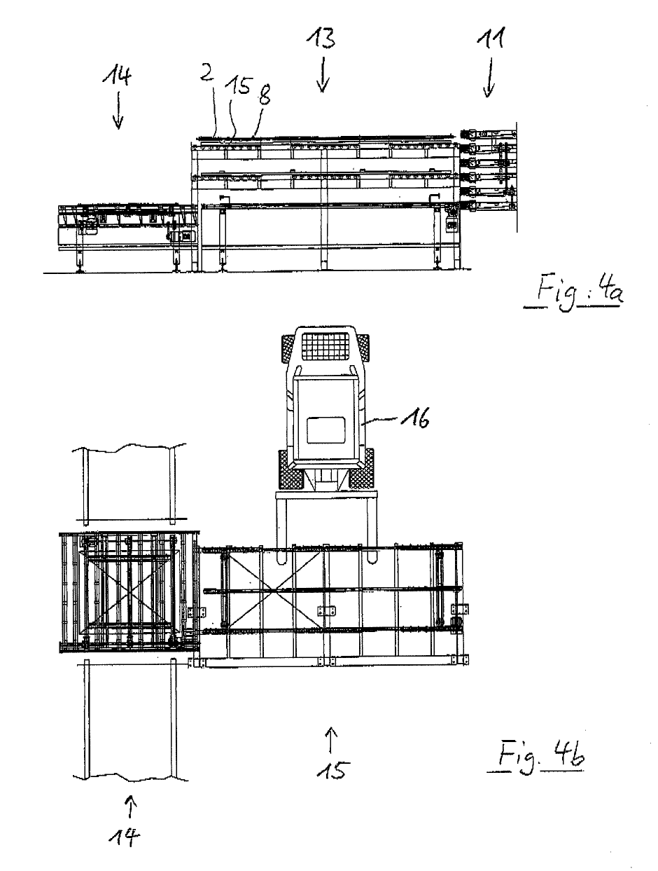

FIGS. 4a and 4b show, in corresponding diagrams, a modification of the membrane frame replacement station 13 from FIGS. 3a and 3b. This modification consists in that the membrane frame replacement station 13 is constructed essentially as a transport section between the cross transport device 14 (that could then also be a longitudinal transport device) and the loading basket 11, wherein the fork stacker 16 can remove any discharged membrane frames 2 (with transport frames 15) out from the membrane replacement station 13 and a new membrane frame 2 (with transport frame 15) can be loaded there again, in order to feed it via the loading basket 11 into the corresponding press stage.

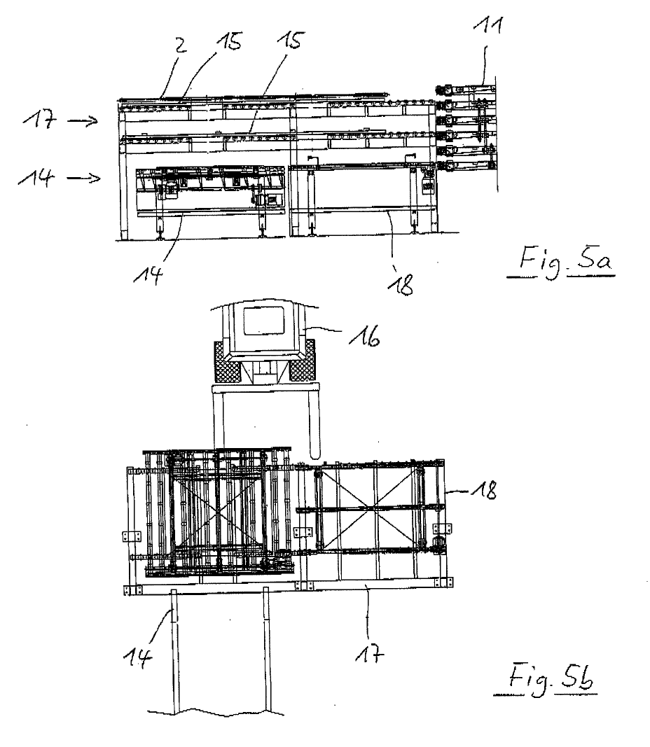

FIGS. 5a and 5b show, in turn, in a side view and a top view, another modification of a membrane-frame magazine 17. This membrane-frame magazine is arranged, in turn, in front of the loading basket 11, but the cross transport device 14 for feeding the workpieces to be laminated is arranged neither before nor after, but instead next to the membrane-frame magazine 17. This is achieved in that the membrane-frame magazine 17 is arranged above the cross transport device 14 and a short longitudinal transport section 18 and is correspondingly allocated directly to the loading basket 11. In this way, the height adjustability of the loading basket 11 is used optimally. In the membrane-frame magazine 17, a number of ready-to-use membrane frames 2 on transport frames 15 are stored in magazines, in order to provide a multi-stage press with several new membranes within a short time.

1. A press for laminating essentially plate-shaped workpieces under the effect of pressure and heat, comprising a lower press half (1′) and an upper press half (1) that form, in a closed state, a vacuum chamber (7) therebetween utilizing a peripheral, one-part or multi-part seals (6), a flexible membrane (8) divides the vacuum chamber (7) into a product half (9) that can be evacuated and that is provided for holding at least one workpiece, and a pressure half (10) that can be pressurized, the membrane (8) is constructed and arranged so that it presses the workpiece directly or indirectly against a bottom side of the vacuum chamber (7) due to a pressure difference in the vacuum chamber (7) generated by at least one of evacuation of the product half (9) or a pressurization of the pressure half (10), and the membrane (8) is mounted on a membrane frame (2) that is connected detachably to the upper press half (1) and that can be handled separately, and a membrane-frame magazine (17) for storing at least one ready-to-use membrane frame (2) with a membrane (8) mounted on the ready-to-use membrane frame as a replacement frame.

2. The press according to claim 1, wherein the press comprises at least one of a loading or unloading devices for feeding and discharging the workpieces into and out of the vacuum chamber (7), the loading or unloading devices are also provided for feeding and discharging the membrane frame (2) into and out of the vacuum chamber (7).

3. The press according to claim 2, wherein transport frames (15) for the membrane frames (2) are provided on which the membrane frames (2) can be at least one of fed or discharged by the loading or unloading devices into and out of the vacuum chamber (7).

4. The press according to claim 3, wherein the transport frames (15) are provided with lift elements that can be activated by hand for lifting the membrane frame (2).

5. The press according to claim 2, wherein a membrane frame replacement station (13) is allocated to the loading or unloading devices.

6. The press according to claim 1, wherein the membrane frame (2) is mounted on the upper press half (1) by quick-release closures (3).

7. The press according to claim 1, wherein the membrane frame (2) within the vacuum chamber (7) is mounted on the upper press half (1).

8. The press according to claim 1, wherein the press comprises a multi-stage press in which several of the press stages are arranged one above the other each having one of the lower press halves (1′) and the upper press halves (1) for each press stage, wherein together these halves form respective ones of the vacuum chambers (7) and wherein each of the press stages has one of the membrane frames (2) with the membrane (8) mounted on the frame that can be handled separately and that is mounted detachably to the corresponding upper press half (1).

9. The press according to claim 8, wherein for loading the press stages, a multi-stage loading basket (11) is provided with a membrane frame stage (12).

10. A method for laminating essentially plate-shaped workpieces under the effect of pressure and heat comprising:
providing a press for laminating essentially plate-shaped workpieces under the effect of pressure and heat, comprising a lower press half (1′) and an upper press half (1) that form, in a closed state, a vacuum chamber (7) therebetween utilizing a peripheral, one-part or multi-part seals (6), a flexible membrane (8) divides the vacuum chamber (7) into a product half (9) that can be evacuated and that is provided for holding at least one workpiece, and a pressure half (10) that can be pressurized, the membrane (8) is constructed and arranged so that it presses the workpiece directly or indirectly against a bottom side of the vacuum chamber (7) due to a pressure difference in the vacuum chamber (7) generated by at least one of evacuation of the product half (9) or a pressurization of the pressure half (10), and the membrane (8) is mounted on a membrane frame (2) that is connected detachably to the upper press half (1) and that can be handled separately, and a membrane-frame magazine (17) for storing at least one ready-to-use membrane frame (2) with a membrane (8) mounted on the ready-to-use membrane frame as a replacement frame,
introducing at least one workpiece into the vacuum chamber in the product half,
pressing the workpiece by the membrane due to a pressure difference generated by at least one of evacuation of the product half or pressurization of the pressure half in the vacuum chamber directly or indirectly against a bottom side of the vacuum chamber, in order to perform the lamination process, and
storing at least one membrane frame with a membrane mounted on the frame as a replacement frame outside of the press.

11. The method according to claim 10, wherein
a membrane-frame magazine with at least two stages is allocated to the press, wherein, in a first stage of the membrane-frame magazine, a membrane frame is stored as a replacement frame and if there is a membrane defect, the membrane frame with the defective membrane in the vacuum chamber is removed into a second stage of the membrane-frame magazine, after which the prepared membrane frame stored as the replacement frame is introduced into the vacuum chamber.

12. The method according to claim 11, further comprising using loading and/or unloading devices for feeding and discharging workpieces into and out of the vacuum chamber of the press for feeding and discharging the membrane frames into and out of the vacuum chamber.

13. The method according to claim 12, further comprising
introducing the membrane frames into and taking them out from the vacuum chamber on transport frames.

14. The method according to claim 13, wherein
the membrane frames are lifted toward the upper press half after introduction into the vacuum chamber by lift elements arranged in the transport frame in order to be able to be mounted there.

15. The method according to claim 14, wherein the lift elements can be activated by hand.
